(19) United States
(12) Patent Application Publication
(10) Pub. No.: US 2019/0205785 A1
(43) Pub. Date: Jul. 4, 2019

(54) EVENT DETECTION USING SENSOR DATA

(71) Applicant: Uber Technologies, Inc., San Francisco, CA (US)

(72) Inventors: Nikolaus Paul Volk, San Francisco, CA (US); Theofanis Karaletsos, San Francisco, CA (US); Upamanyu Madhow, Santa Barbara, CA (US); Jason Byron Yosinski, San Francisco, CA (US); Theodore Russell Sumers, San Francisco, CA (US)

(21) Appl. No.: 16/233,779

(22) Filed: Dec. 27, 2018

Related U.S. Application Data
(60) Provisional application No. 62/611,465, filed on Dec. 28, 2017.

(51) Int. Cl. G06N 20/00; G06N 5/04

(52) U.S. Cl. CPC G06N 20/00; G06N 5/04

(57) ABSTRACT

Systems and methods for training models and using the models to detect events are provided. A networked system assembles one or more triplets using sensor data accessed from a plurality of user devices, the assembling including applying a weak label. The networked system autoencodes the one or more triplets based on a covariate to generate a disentangled embedding. A model is trained using the disentangled embedding, whereby the model is used at runtime to detect whether an event associated with the model is present. In particular, runtime sensor data from the real world is autoencoded to generate a runtime embedding, whereby the runtime sensor data comprising sensor data from at least one of a device of a user. The runtime embedding is comparted to one or more embeddings of the model, whereby a similarity in the comparing indicates the event associated with the model occurring in the real world.

### CROSS REFERENCE TO RELATED APPLICATION

The present application claims the priority benefit of U.S. Provisional Patent Application Ser. No. 62/611,465 filed on Dec. 28, 2017 and entitled “Weakly- and Semi-Supervised Disentangled Triplet Embedding from Sensor Time Series,” which is incorporated herein by reference.

### TECHNICAL FIELD

The subject matter disclosed herein generally relates to special-purpose machines for training models including computerized variants of such special-purpose machines and improvements to such variants. In particular, the special-purpose machines use weakly- and semi-supervised disentangled embedding from sensor time series to train models. Specifically, the present disclosure addresses systems and methods to train models and use the trained models to detect events from real world sensor data.

### BACKGROUND

Conventionally, sensor information from platforms acting in and sending from the real world arrives in the form of sensor time series from mobile devices. The sensor information may comprise, for example, accelerometer and gyroscope readings. Machine learning techniques applied to this sensor information can be useful. However, conventional supervised machine learning techniques require a large set of clean labels on top of the sensor time series, which is difficult and expensive to obtain due to the scale of the collected sensor information and specific characteristics of the sensor information from the mobile devices. Such specific characteristics include, for example, high sampling rate, significant noise (e.g., due to cheap mobile sensors), and significant heterogeneity through a huge variation across mobile devices and sensors.

### BRIEF DESCRIPTION OF THE DRAWINGS

Some embodiments are illustrated by way of example and not limitation in the figures of the accompanying drawings.

FIG. 1 is a diagram illustrating a network environment suitable for training inference models and using the trained inference models to detect events from sensor data, according to some example embodiments.

FIG. 2 is a block diagram illustrating components of a networked system, according to some example embodiments.

FIG. 3 is a block diagram illustrating components of the training engine, according to some example embodiments.

FIG. 4 is a block diagram illustrating components of the runtime engine, according to some example embodiments.

FIG. 5 is a flowchart illustrating operations of a method for training inference models, according to some example embodiments.

FIG. 6 is a flowchart illustrating operations of a method for detecting events using trained inference models, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments provides example methods (e.g., algorithms) that train inference models and facilitate event detection using the trained inference models, and example systems (e.g., special-purpose machines or devices) are configured to facilitate training of inference models and event detection using the trained inference models. In particular, example embodiments provide mechanisms and logic that provide a flexible deep learning framework which can exploit both known information as well as coarse information available within a platform (e.g., ridesharing platform) to extract “weak labels” for training models, thus obviating the need for explicit labeling. The framework enables mapping of sensor data over a time window into a vector of relatively low dimension, which provides a general-purpose “embedding” on top of which additional downstream inferences and learning tasks may be layered in order to train the models. Embeddings comprise a latent code in three-dimensional space. Specifically, an embedding is a structured representation of data in a way easier to consume in space that is used to make decision or compare with single points during runtime. Training the models results in the embeddings referring to a specific event (e.g., co-presence, fraud, dangerous driving).

In one example, a networked system knows when a trip starts and when it ends in a ridesharing platform. The information is noisy and can be off by a few seconds. However, the networked system can use the information to extract value from sensor data obtained from user devices of the driver and rider. While the information does not provide a level of detail that indicates that a noisy GPS signal comes from the rider opening the door (e.g., to start the trip), there is weak information based on known sequences of events taking place (e.g., request ride, get in vehicle at pick-up location, travel, get out of vehicle at drop-off location).

During runtime, the trained models are used to detect events based on sensor data received from one or more user devices. The detected events can include, for example, co-presence of a driver and a rider, fraud, dangerous driving, an accident, phone handling issues, or a trip state. As a result, one or more of the methodologies and systems described herein facilitate solving the technical problem of conventional machine learning techniques that require a large set of clean labels. Additionally, the methodologies and systems enable the use of the resulting machine-learned models to detect events occurring in the real world.

In particular, the present disclosure provides technical solutions for training inference models using sensor data from a plurality of user devices. The trained models can then be used to analyze runtime sensor data for purposes such as, for example, safety and fraud detection. In example embodiments, the sensor data comprises trip data from a ridesharing platform. Accordingly, a technical solution involves systems and methods that periodically analyze sensor data obtained prior to, during, and upon completion of a transportation service (also referred to as “trip data”) in order to dynamically train inference models based on embeddings (e.g., triplet embeddings) generated from the sensor data and known labels. In example embodiments, a networked system obtains and stores the sensor data. The stored sensor data comprises information detected from a user device that is used in providing or obtaining a transportation service between a pick-up location (PU) and a drop-off location (DO). The transportation service can be to transport people, food, or goods.

In example embodiments, the networked system pre-processes the sensor data to align the sensor data to a lower frequency. Using the sensor data and known weak labels, the networked system assembles the triplets. In example embodiments, the triplets (e.g., three-way pairs) comprise two statements of data that are more similar to each other than two other statements. Subsequently, using one or more triplets and one or more covariates, the networked system auto-encodes the sensor data. The covariates comprise hard knowledge or latent labels. The result of the auto-encoding is a disentangled embedding that trains the inference model. The inference models are then used, during runtime, to detect events such as co-presence or fraud.

During runtime, the networked system detects sensor data from one or more user devices in the real world. Using the sensor data, the networked system pre-processes and auto-encodes the sensor data to create one or more runtime embeddings. The one or more runtime embeddings are then compared to the trained models to determine an inference output. For example, if the downstream task is to determine co-presence, the one or more runtime embeddings are analyzed using a co-presence model to determine whether sensor data from two devices (e.g., a driver device and a rider device) indicates that the two devices are co-present.

Thus, example methods (e.g., algorithms) and example systems (e.g., special-purpose machines) are configured to machine train inference models and use the trained models to detect events. One embodiment provides a flexible deep learning framework which can exploit both known information (e.g., also referred to as covariates or hard labels) as well as coarse information available within a platform (e.g., ride sharing platform) to extract “weak labels” for training, thus obviating the need for the explicit labeling required in conventional system. The framework enables mapping of the sensor data over a time window into a vector of relatively low dimension, which provides a general-purpose “embedding” on top of which additional downstream inference and learning tasks can be layered. In example embodiments, the embedding is general-purpose enough to support a variety of inference tasks and disentangles specific features of interest associated with the weak labels used to train the models. In order to obtain these results, two complementary concepts are combined: autoencoders, which enables supporting a variety of inference tasks, and weak supervision (e.g. via triplet or Siamese networks), which enables disentangling of specific features of interest associated with weak labels user to train the models.

With weak supervision, instead of explicitly associating a label with a training example, the networked system considers pairs or triplets of training examples, and provide “weak” labels on whether or not the pairs or triplets are similar. These labels are “weak” because they can be noisy and/or missing, and complete supervision of what the model's output should be is not performed. Instead, the networked system only considers that two outputs should be similar or different. For example, in a triplet embodiment, similar training examples A and B, and dissimilar example C are fed to the networked system (e.g., a same neural network), which outputs embedding vectors x(A), x(B), and x(C). A cost function on which the networked system is trained is that the Euclidean distance (or some other (dis)similarity measure) between x(A) and x(B) should be smaller than that between x(A) and x(C).

With respect to the autoencoder, the autoencoder maps a training example A to an embedding vector x(A) such that the networked system (e.g., a first neural network) can then reconstruct A by passing x(A) through a decoder (e.g., a second neural network). A cost function based on which the encoder and decoder are trained is a reconstruction error, together with other regularizations which vary across different autoencoder architectures. A variational autoencoder, for example, is a specific type of autoencoder which makes assumptions of the distribution of the latent embedding and requires an additional loss term as a function of the Kullback Leibler divergence.

Example embodiments combine weak supervision and autoencoding, and its adaptation, to applications associated with various platforms including ridesharing. A feature of example embodiments includes use of weak supervision in a similarity metric learning paradigm. A ridesharing-specific example is that the networked system can use co-presence of riders and drivers when they are travelling together to impose similarity structure onto representations. In another example, the networked system uses temporal “proximity” to establish similar structures and smoothness across the time series. Another feature of example embodiments is that the networked system uses partially known “covariates” (e.g., phone model, operating system, collection mode, such as rider vs. driver) and semi-supervised learning to condition the networked system on these covariates or partially known latent factors. Further still, example embodiments use an autoencoding component which aims to reconstruct the data and captures the best possible data characteristics which are not captured by previous tasks. In one embodiment, the autoencoding component is a variational autoencoder, but other forms of autoencoders may be used.

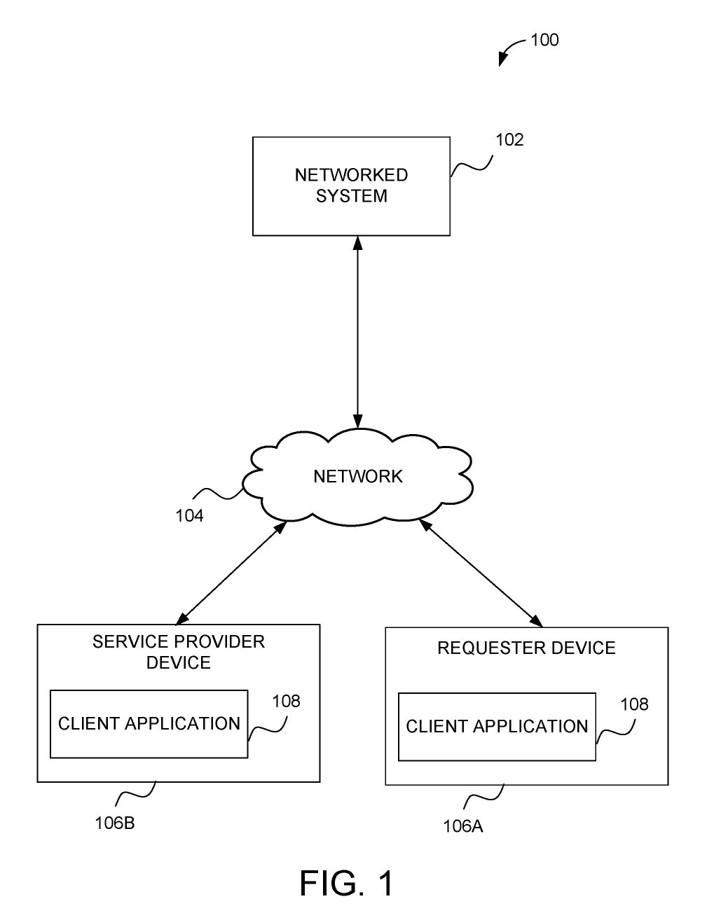

FIG. 1 is a diagram illustrating a network environment 100 suitable for training inference models and using the trained inference models to detect events from sensor data, according to example embodiments. For simplicity of discussion, an example embodiment within a transportation service platform is discussed in detail below. However, example embodiments can be implemented in other platforms in which large amounts of data are used to train models, Therefore, the present disclosure should not be limited to transportation service platforms.

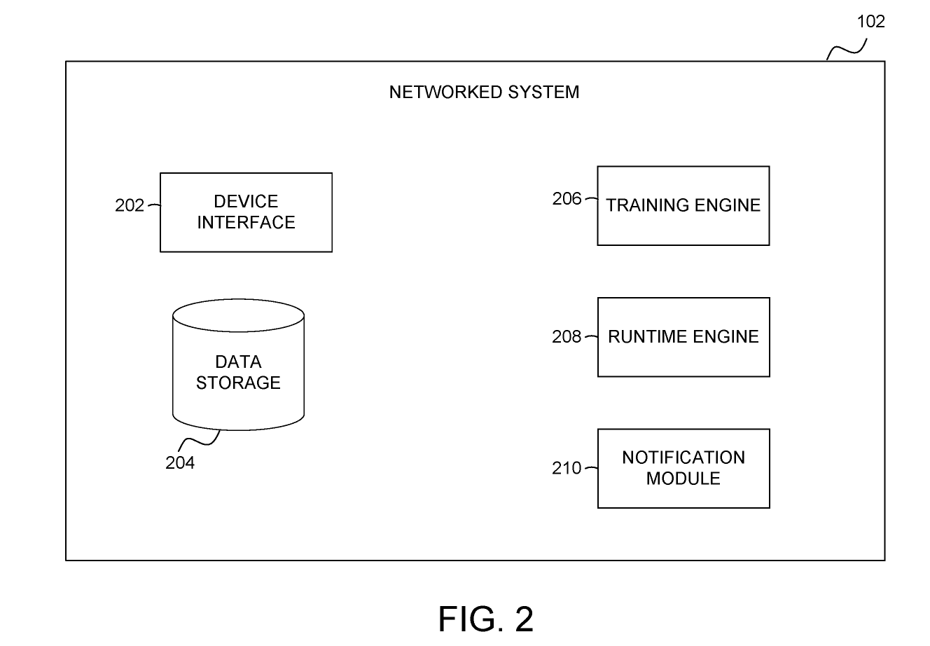

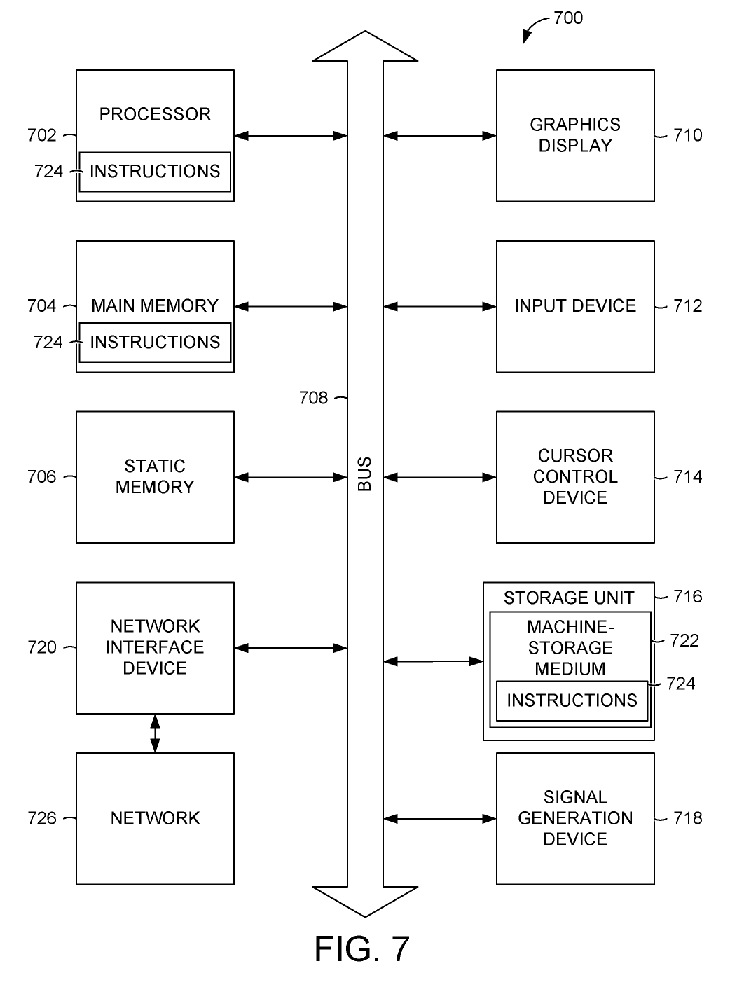

The network environment 100 includes a networked system 102 communicatively coupled via a network 104 to a requester device 106a and a service provider device 106b (collectively referred to as “user devices 106”). In example embodiments, the networked system 102 comprises components that obtain, store, and analyze data received from the user devices 106 and other sources in order to machine-train inference models and use the inference models, during runtime, to detect events. The components of the networked system 102 are described in more detail in connection with FIG. 2 to FIG. 4 and may be implemented in a computer system, as described below with respect to FIG. 7.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. Alternatively, the service provider device 106b can correspond to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The user devices 106 interact with the networked system 102 through a client application 108 stored thereon. The client application 108 of the user devices 106 allow for exchange of information with the networked system 102 via user interfaces as well as in the background. For example, sensors on or associated with user devices 106 capture sensor data such as location information (GPS coordinates), inertial measurements, orientation and angular velocity (e.g., from a gyroscope), altitude, Wifi signal, ambient lights, or audio. The sensor data is then provided to the networked system 102, via the network 104 by the client application 108, for storage and analysis (e.g., by the client application 108). In some cases, the sensor data includes known facts (also referred to as “covariates”) about the user devices 106 such as phone model, operating system, collection mode (e.g., whether data is from a rider or driver), and device identifier.

In example embodiments, a first user (e.g., a rider) operates the requester device 106a that executes the client application 108 to communicate with the networked system 102 to make a request for transport or delivery service (referred to collectively as a “trip”). In some embodiments, the client application 108 determines or allows the user to specify a pick-up location (e.g., of the user or an item to be delivered) and to specify a drop-off location for the trip. The client application 108 also presents information, from the networked system 102 via user interfaces, to the user of the requester device 106a. For instance, the user interface can display a notification that the first user is in a wrong vehicle.

A second user (e.g., a driver) operates the service provider device 106b to execute the client application 108 that communicates with the networked system 102 to exchange information associated with providing transportation or delivery service (e.g., to the user of the requester device 106a). The client application 108 presents information via user interfaces to the user of the service provider device 106b, such as invitations to provide transportation or delivery service, navigation instructions, pickup and drop-off locations of people or items, and notifications of illegal stopping zones. The client application 108 also provides the sensor data to the networked system 102 such as a current location (e.g., coordinates such as latitude and longitude) of the service provider device 106b and accelerometer data (e.g., speed at which a vehicle of the second user is traveling).

In example embodiments, any of the systems, machines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100. Furthermore, some components or functions of the network environment 100 may be combined or located elsewhere in the network environment 100. For example, some of the functions of the networked system 102 may be embodied within other systems or devices of the network environment 100. Additionally, some of the functions of the user device 106 may be embodied within the networked system 102. While only a single networked system 102 is shown, alternative embodiments may contemplate having more than one networked system 102 to perform server operations discussed herein for the networked system 102.

FIG. 2 is a block diagram illustrating components of the networked system 102, according to some example embodiments. In various embodiments, the networked system 102 obtains and stores trip information (e.g., pick-up and drop-off locations, routes, selection of routes) and sensor data received from the user devices 106, analyzes the trip information and sensor data, trains inference models, and uses the inference models to detect events during runtime. To enable these operations, the networked system 102 comprises a device interface 202, a data storage 204, a training engine 206, a runtime engine 208, and a notification module 210. The networked system 102 may also comprise other components (not shown) that are not pertinent to example embodiments. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The device interface 202 is configured to exchange data with the user devices 106 and cause presentation of one or more user interfaces or notifications (e.g., generated by the notification module 210) on the user devices 106 including user interfaces having notifications of, for example, a wrong pick-up, wrong driver, or wrong rider. In some embodiments, the device interface 200 generates and transmits instructions (or the user interfaces themselves) to the user devices 106 to cause the user interfaces to be displayed on the user devices 106. The user interfaces can be used to request transportation or delivery service from the requester device 106a, display invitations to provide the service on the service provider device 106b, present navigation instructions including maps, and provide notifications. At least some of the information received from the user devices 106 including the sensor data are stored to the data storage 204.

The data storage 204 is configured to store information associated with each user (or user device) of the networked system 102. The information includes various trip data and sensor data used by the networked system 102 to machine-learn inference models. In some embodiments, the data is stored in or associated with a user profile corresponding to each user and includes a history of interactions using the networked system 102. The data storage 204 may also store data used for machine learning the inference models as well as the trained inference models (e.g., labels). While the data storage 204 is shown to be embodied within the networked system, alternative embodiments can locate the data storage elsewhere and have the networked system 102 communicatively coupled to the networked system 102.

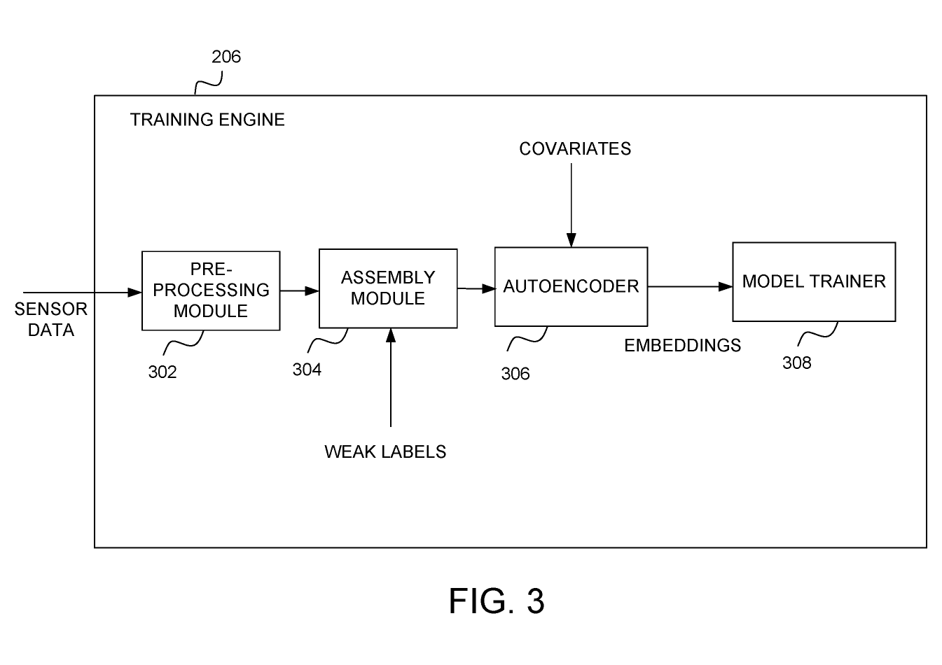

The training engine 206 is configured to access trip information and sensor data received from the user devices 106, analyze the trip information and sensor data, and train inference models. The training engine 206 will be discussed in more detail in connection with FIG. 3 below.

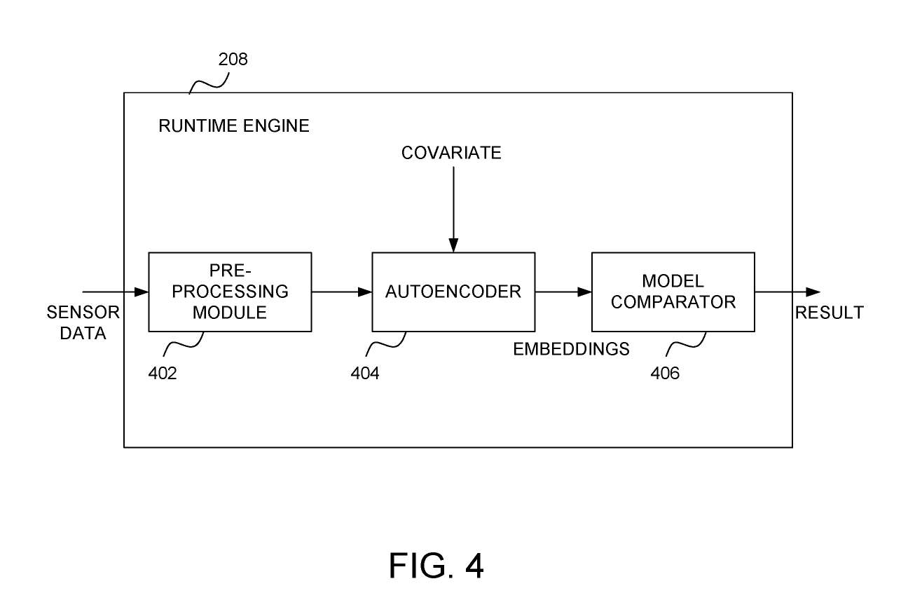

The runtime engine 208 is configured to access real world data and apply the real-world data to the trained inference models to detect events. In some embodiments, the events are happening in real-time (or near real-time). The runtime engine 208 will be discussed in more detail in connection with FIG. 4 below.

The notification module 210 is configured to generate and cause display of notifications on the user devices 106. The notifications can include information regarding the detected events. For example, if a rider got into the wrong vehicle in a ride-sharing embodiment, the notification module 210 causes a notification to be displayed on the user devices 106 of the rider and the driver indicating that the pick-up was in error.

FIG. 3 is a block diagram illustrating components of the training engine 206, according to some example embodiments. In example embodiments, the training engine 206 is configured to access trip information and sensor data received from the user devices 106, analyze the trip information and sensor data, and train inference models. To enable these operations, the training engine 206 comprises a pre-processing module 302, an assembly module 304, an autoencoder 306, and a model trainer 308 all configured to communicate with each other (e.g., via a bus, shared memory, or a switch). The training engine 206 may also comprise other components (not shown) that are not pertinent to example embodiments.

The preprocessing module 302 accesses and preprocesses the sensor data. In one embodiment, preprocessing the sensor data comprises transforming raw sensor data (e.g., 25 Hz) to a smoothed and aligned output (e.g., 5 Hz). The preprocessed sensor data can be fed as windows of 10 s (e.g., 5 Hz*10 s=50 samples) into the autoencoder 306 (e.g., dimension: 500) which can be given weak labels. The resulting embedding (e.g., dimension 32) can be used as features for various downstream models (e.g., an inference model for co-presence; an inference model for fraud).

As an example using co-presence, rider/driver co-presence is used to first shape a first 16 dimensions of an embedding. The resulting embedding (e.g., full 32 dimensions) serves as input for the co-presence inference model (e.g., a simple logistic regression). As such, for this example, a first hidden layer dim=200; a second hidden layer dim=32; an output dim=32, a batch_size=64, and query_mask dim=16.

In general, the training engine 206 uses weak labels to assemble, in the assembly module 304, triplets that are provided together with their covariates into the autoencoder 306 (e.g., a Triplet Variational Autoencoder (TripletVAE)) which generates disentangled embeddings which is used to train a model that can be used for multiple downstream tasks, such as event detection. In example embodiments, the disentangled embeddings have a fixed number of dimensions to represent a certain weak label (e.g., 1, 2, 3, . . . ) and certain dimensions to represent an autoencoded structure (e.g., 0). The triplet is a way to contrast different things—thus it is weak supervision. While the networked system 102 cannot detect which thing is what exactly, the networked system can identify one thing as being closer to another thing. Based on observations of many triplets, a constraint about what a thing or event is can be established. The weak labels are provided to the assembly module 304. These weak labels are similarity statements that are used to construct the triplets and build the data set of triplets.

By using example embodiments, the training engine 206 (e.g., the autoencoder 306) disentangles different underlying latent factors (e.g., the covariates) from the time series in a meaningful and interpretable way. As a result, the training engine 206 can combine these components in a flexible and modular manner, and train jointly for specific downstream tasks. For example, sensor data embeddings for a rider and driver, together with other covariates (e.g., operating system, phone model), are used to infer (e.g., via another neural network) a probability that the rider and driver are co-present over a given time window. The probabilities over multiple windows are then combined to build up confidence in whether or not the rider and driver are co-present (e.g., using a Sequential Probability Ratio Test (SPRT)). The results of the SPRT, in turn, can be used to flag events related to fraud (e.g., based on GPS spoofing) or safety (e.g., a rider being picked up by the wrong driver).

In some embodiments, the sensor data embeddings are used within more complex sequential models, for example, a conditional random field (CRF) or a hidden Markov model (HMM). Such a model can, for example, be used to estimate and track a state of a ridesharing trip from pre-pickup to post-dropoff. Another example is estimation of important state transitions of a courier operating within a delivery system, which may include states such as “driving to a restaurant,” “waiting for food to be ready,” “driving to delivery destination,” or “making the delivery.”

Example embodiments combine concepts from a variational autoencoder and similarity learning using weak labels. In particular, the autoencoder 306 learns general structure by reconstructing the data, and the assembly module 304 (e.g., a triplet-based distance learning component) learns structure from weak labels using distance metrics. By combining these ideas and components, the training engine 206 creates a training instance which combines different objective functions/losses. An example equation is:

Lₜₒₜₐₗ=L_{reconstruct}+L_{T}(+L_{KL/VAE})(+L_{reg})

where

L_{reconstruct} is a reconstruction loss from the autoencoder 306.

L_{T} is the triplet loss (e.g., a similarity loss) with L_{T}=Lₜᵣᵢₚₗₑₜ=max{0, D(xᵢ, xⱼ)−D(xᵢ, xₖ)+h}. h is a given margin, xᵢ, xⱼ are similar pairs, and xᵢ, xₖ are dissimilar pairs.

L_{KL/VAE} is the (optional) KL-divergence loss when using variational inference as an approximation technique.

L_{reg} is an additional optional regularization loss, which may be optional.

In one embodiment, the autoencoder 306 comprises three identical autoencoders (e.g., variational autoencoders, VAEs) which share weights amongst each other. A connection does not happen on the full dimension of the latent embedding but happens on a subspace (referred to as a mask) of the embedding. By doing this, the embedding is forced to capture structure from a weakly supervised task and flexibility to reconstruct other structures not addressed by the weakly supervised task is enabled.

In some embodiments, another transformation is introduced from the masked embedding towards a variable. By doing this, the structure is not forced to adhere to a fixed margin within a distance learning task. For example,

x_{i,j,k}′=Wx_{i,j,k}+b

D(xᵢ, xⱼ) becomes D(xᵢ′, xᵢ′)

D(xᵢ, xₖ) becomes D(xⁱ′, xₖ′).

Example embodiments add covariates to condition the models on known information. The basic idea is to disentangle known facts (e.g., the covariates) or partially available labels (through semi-supervised learning), weak labels, and other characteristics through autoencoding by the autoencoder 306. In order to disentangle known facts, the autoencoder 306 includes ground truth facts about each sensor data window as covariates c. For example, an embedding z will be conditioned not only on the sensor data but also on the covariates or latent factors c which an encoder network g receives as additional inputs. Thus, for example,

p(z|x,c)=g(x,z).

Decoding is performed in an identical way. For example

q(x|z, c)=f(z, c).

In one embodiment, as “ground truth” covariates, the training engine 206 first chooses the operating system and the mode (e.g., rider vs driver). However, this can be extended by other known facts from the sensor time series. If c is only partially observed, the training engine 206 can utilize a prior distribution p(c) to infer a distribution over latent factors. This effectively applies semi-supervised learning to this part of the latent space. Examples for partially observed variables can be retrieved from fraud or safety related incidents which are only partially reported.

In one embodiment, the triplets are assembled, by the assembly module 304, to train the embedding using a weak label. In one example, the weak label is co-presence of the driver and rider based on driver and rider sensor data. Other weak labels can include, for example, noisy inputs from phone handling or mounting classifier and activities (e.g., walking, driving, idling a vehicle). For co-presence as the weak label, the assembly module 304 assembles positive pairs when rider and driver are co-present (e.g., in the same vehicle) on a trip and negative pairs when the rider and driver are not co-present. Start and end of the trip can be used as noisy label heuristics. Based on these pairs, the training engine 206 samples triplets of the form (sim, sim, dissim) and feeds them into the model.

The model trainer 308 uses the embeddings for training models for downstream tasks and applications. One immediate downstream application is that the model trainer 308 can use the established embeddings to train a similarity classifier on top of the embeddings which gives the model trainer 308 a probability of being co-present P(co-present embedding). In one embodiment, the model trainer 308 uses a simple Logistic Regression but can limit any sort of supervised classification algorithm or even the Euclidean Distance in a most basic version. By doing this, the model trainer 308 establishes a “sensor-driven” distance which is orthogonal to a real “physical” distance. The sensor-based P(copresence) can be used for different downstream applications.

In further embodiments, the embeddings can be used to train activity classifiers (e.g., by the model trainer 308) for walking (e.g., by a rider to a pick-up location, by a driver to a restaurant for a delivery service), driving, idling, running, climbing stairs, and any other activity that is detectable by sensors on the user device 106. Further still, sequence models such as sequential probability ratio test (SPRT), conditional random fields (CRFs), or hidden Markov models (HMMs) can be used together with the embeddings to train more intelligent state models (e.g., for ride-hailing, other mobility services, or delivery). These state models can include, for example, riding a train, riding a bus, walking from the office, home, or other location to the pickup, walking from a drop-off to the office, home, or other location, walking from the vehicle to a restaurant, walking from a plane to a luggage carousel, etc. Another possibility is to train a sequence model such as a CRF or HMM jointly with the embeddings.

FIG. 4 is a block diagram illustrating components of the runtime engine 208, according to some example embodiments. In example embodiments, the runtime engine 208 is configured to detect events using the trained inference models generated by the training module 206. To enable these operations, the runtime engine 208 comprises a preprocessing module 402, an autoencoder 404, and a model comparator 406 all configured to communicate with each other (e.g., via a bus, shared memory, or a switch). The runtime engine 208 may also comprise other components (not shown) that are not pertinent to example embodiments.

In example embodiments, the preprocessing module 402, preprocesses real-world sensor data. In some cases, the real-world sensor data is received and preprocessed in real-time (or near real-time). The preprocessing module 402 functions similar to the preprocessing module 302 of the training engine 206. For example, the preprocessing module 402 can transform raw sensor data (e.g., 25 Hz) to a smoothed and aligned output (e.g., 5 Hz).

The preprocessed sensor data is then provided to the autoencoder 404. The autoencoder 404 applies one or more covariates to the sensor data and generates codes (e.g., embeddings). The embeddings are then compared, by the model comparator 406 to embeddings associated with an inference model. When a match is detected, a corresponding event associated with the inference model is identified.

One use case is in a safety context. A “wrong driver” issue is a real and serious concern for ridesharing companies. Using sensor-based co-presence (e.g., sensor data from a driver and a rider) plus a trained model, the runtime engine 208 can detect early during a potential trip (e.g., when the rider enters a vehicle) whether the co-presence predictions for rider and driver indicate co-presence. Another use case in a trip metric context involves pick-up and drop-off detection or mistimed trips. Accurate trip start and end are key metrics in ridesharing. Using sensor-based co-presence (e.g., sensor data from a driver and a rider), the runtime engine 208 detects the start and end of a trip based on the sensor data. Additionally, the runtime engine 208 can classify entry and exit periods, individually, by using the embedding to train a “pickup window” classifier/model.

Another use case is fraud. In some cases, users commit fraud by creating new rider/driver accounts on the same device. An ability to assign a “fraud score” to a device would be helpful. Unfortunately, fraudsters can wipe all software device identifiers, preventing the networked system 102 from knowing that it is the same device. As a solution, individual sensors (e.g., accelerometer, gyroscopes) are subject to slight manufacturing differences which produce characteristic signatures. By identifying and mapping these sensors to a particular device, the networked system can identify the same device being re-used despite wiping the software identifiers.

A further use case is a wrong pick-up (e.g., rider starts a rider with a wrong driver). Thus, it would be ideal to detect whether a rider has entered a correct vehicle (versus another vehicle which is not a vehicle of the assigned driver). However, this is challenging because (1) GPS is noisy in urban environments and (2) there is limited access to rider sensor data (e.g., can have motion sensors without GPS). As such, a principled method to integrate partial/noisy signal and determine co-presence allows the networked system 102 to take well-calibrated action such as provide a notification via the notification module 210 or call the rider and driver to provide a verbal notification that the rider is in the wrong vehicle.

Various safety use cases are also contemplated. In a dangerous driving context, incident tickets (e.g., reports by a rider of dangerous driving) can be noisy. However, these incident tickets can be used as a weak label to generate embeddings for dangerous trips and train a model or classifier. In an accident context, claim tickets can be noisy in terms of severity and dollar loss amount. Similarly, the claim tickets can be used to train an embedding for accident trips. In yet another example, phone handling (e.g., by a driver) can be an issue. Using heuristics or other classifiers as weak labels, the networked system 102 can generate a best possible representation of a sensor embedding for a “phone handling state.”

Various trip state models and state sequences can also be contemplated. Trip state models detect an activity during a trip (e.g. picking up, idling, driving, dropping off). In a food delivery service embodiment, sensor data obtained from driving to parking, from parking to walking-to-restaurant, pickup-food to walking to car, and so forth is accessed and used to generate embeddings. As a result, the networked system 102 can learn wait times, parking times or other inefficiencies at restaurants in a food delivery embodiment.

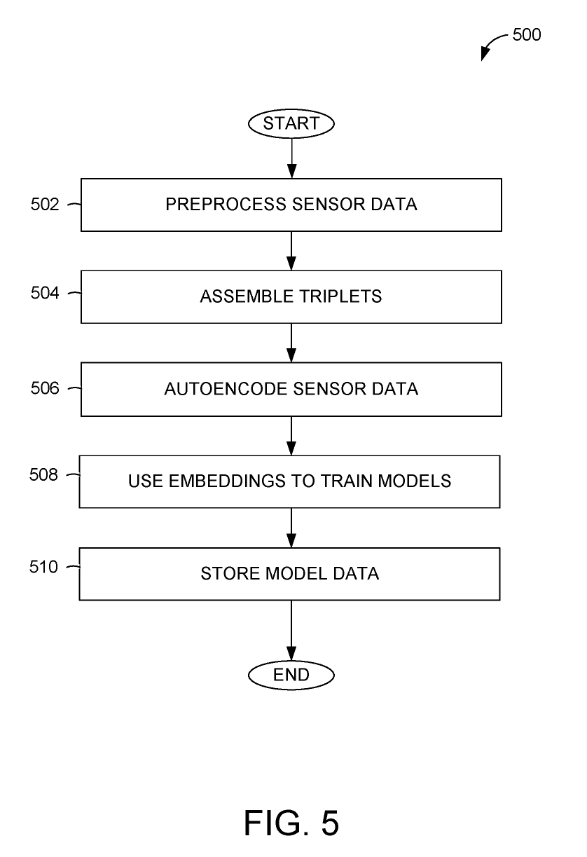

FIG. 5 is a flowchart illustrating operations of a method 500 for training inference models, according to some example embodiments. Operations in the method 500 may be performed by the networked system 102, using components described above with respect to FIG. 2 and FIG. 3. Accordingly, the method 500 is described by way of example with reference to the networked system 102 and the training engine 206. However, it shall be appreciated that at least some of the operations of the method 500 may be deployed on various other hardware configurations or be performed by similar components residing elsewhere in the network environment 100. Therefore, the method 500 is not intended to be limited to the networked system 102.

In operation 502, the preprocessor module 302 preprocesses sensor data. In example embodiments, the sensor data is accessed and preprocessed in batch mode. In other embodiments, the sensor data is preprocessed as it is received from sensors associated with user devices. In one embodiment, preprocessing the sensor data comprises transforming raw sensor data (e.g., 25 Hz) to a smoothed and aligned output (e.g., 5 Hz). It is noted that in some embodiments, operation 502 is optional.

In operation 504, the assembly module 304 assembles triplets using the preprocessed sensor data. In example embodiments, the triplets (e.g., three-way pairs) comprise two statements of data that are more similar to each other than two other statements. The triplets are assembled based on weak labels. These weak labels are similarity statements (e.g., indicating whether or not the pairs or triplets are similar) used to construct the triplets. These labels are “weak” because they can be noisy and/or missing, and complete supervision of what the model's output should be is not performed. Instead, the networked system only considers that two outputs should be similar or different.

In operation 506, the autoencoder 306 autoencodes the sensor data. In example embodiments, the autoencoder 306 receives the triplets from the assembly module and disentangles the triplets using covariates. The covariates are hard labels (e.g., known facts) that are “removed” or “disentangled” before training the models. The output of the autoencoder are embeddings.

In operation 508, the embeddings are used in downstream tasks or applications, for example, to train inference models that can be used during runtime to detect events.

In operation 510, the inference models are stored to a data storage (e.g., data storage 204) for use during runtime.

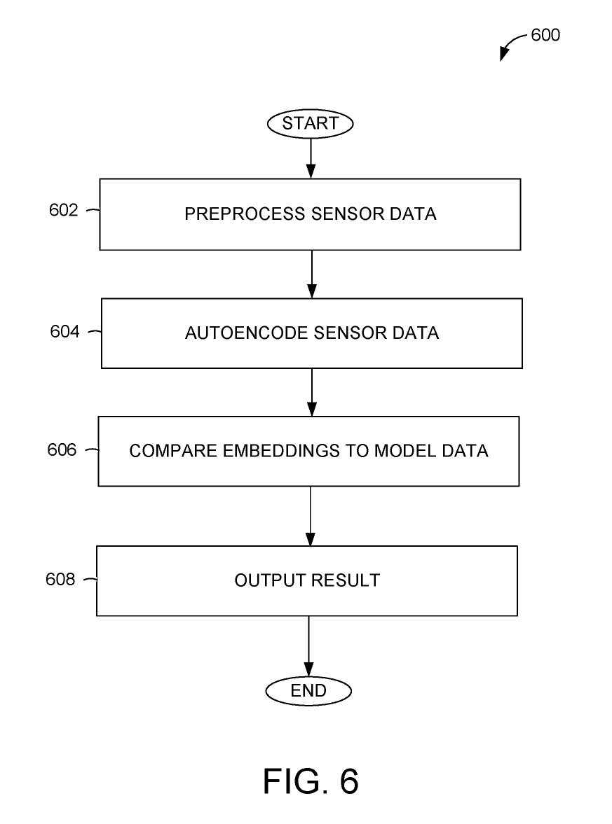

FIG. 6 is a flowchart illustrating operations of a method 600 for detecting events using trained inference models, according to some example embodiments. Operations in the method 600 may be performed by the networked system 102, using components described above with respect to FIG. 2 and FIG. 4. Accordingly, the method 600 is described by way of example with reference to the networked system 102 and the runtime engine 208. However, it shall be appreciated that at least some of the operations of the method 600 may be deployed on various other hardware configurations or be performed by similar components residing elsewhere in the network environment 100. Therefore, the method 600 is not intended to be limited to the networked system 102.

In operation 602, the preprocessing module 402 preprocesses sensor data. In example embodiments, the sensor data is accessed and preprocessed as it is received from sensor devices. In one embodiment, preprocessing the sensor data comprises transforming raw sensor data (e.g., 25 Hz) to a smoothed and aligned output (e.g., 5 Hz). It is noted that in some embodiments, operation 602 is optional.

In operation 604, the autoencoder 404 autoencodes the sensor data. In example embodiments, the autoencoder receives the preprocessed sensor data from the preprocessing module 402 and applies covariates to remove the covariates before comparing to the inference models. The covariates are hard labels (e.g., known facts) that are “removed” or “disentangled” before comparing with one or more inference models. The output of the autoencoder, in one embodiment, are embeddings that can be compared to embeddings of the inference models.

In operation 606, the model comparator 406 compares embeddings from operation 604 to one or more inference models trained by the training engine 206. If the comparison indicates similar or matching embeddings, for example, an event corresponding to the inference model is detected. For example, if the inference model is for co-presence of a driver and a rider, then a comparison of the embeddings would indicate that embedding from the real-world is similar to (or matches) the embeddings used to train the co-presence inference model.

FIG. 7 illustrates components of a machine 700, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIGS. 5 and 6. In one embodiment, the instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-readable medium 722 (e.g., a tangible machine-readable storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-readable media (e.g., tangible and non-transitory machine-readable media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a system for training models and using the models to detect events. The system comprises one or more hardware processors and a memory storing instructions that, when executed by the one or more hardware processors, causes the one or more hardware processors to perform operations comprising accessing sensor data from a plurality of user devices; assembling one or more triplets using the sensor data, the assembling including applying a weak label; autoencoding the one or more triplets based on a covariate to generate a disentangled embedding; and training an inference model using the disentangled embedding, the inference model being used at runtime to detect whether an event associated with the inference model is present.

In example 2, the subject matter of example 1 can optionally include wherein the operations further comprise, during runtime, autoencoding runtime sensor data from the real world to generate a runtime embedding, the runtime sensor data comprising sensor data from at least one of a device of a driver or a device of a rider; comparing the runtime embedding to one or more embeddings of the inference model, a similarity in the comparing indicating the event associated with the inference model occurring in the real world; and outputting a result of the comparing.

In example 3, the subject matter of examples 1-2 can optionally include wherein the outputting the result comprises providing a notification to at least one of the device of the driver or the device of the rider indicating the event.

In example 4, the subject matter of examples 1-3 can optionally include wherein the covariate comprises a known fact associated with the plurality of user devices providing the sensor data, the known fact being disentangled from the triplets prior to training.

In example 5, the subject matter of examples 1-4 can optionally include wherein the covariate comprises one or more of an operating system, phone model, or collection mode.

In example 6, the subject matter of examples 1-5 can optionally include wherein the event comprises co-presence of a driver and rider, fraud, dangerous driving, detection of an accident, phone handling issue, or a trip state.

In example 7, the subject matter of examples 1-6 can optionally include wherein the operations further comprise preprocessing the sensor data prior to the assembling to align the sensor data to a lower frequency.

Example 8 is a method for training models and using the models to detect events. The method comprises accessing, by a networked system, sensor data from a plurality of user devices; assembling, by a processor of the networked system, one or more triplets using the sensor data, the assembling including applying a weak label; autoencoding the one or more triplets based on a covariate to generate a disentangled embedding; and training an inference model using the disentangled embedding, the inference model being used at runtime to detect whether an event associated with the inference model is present.

In example 9, the subject matter of example 8 can optionally include, during runtime, autoencoding runtime sensor data from the real world to generate a runtime embedding, the runtime sensor data comprising sensor data from at least one of a device of a driver or a device of a rider; comparing the runtime embedding to one or more embeddings of the inference model, a similarity in the comparing indicating the event associated with the inference model occurring in the real world; and outputting a result of the comparing.

In example 10, the subject matter of examples 8-9 can optionally include wherein the outputting the result comprises providing a notification to at least one of the device of the driver or the device of the rider indicating the event.

In example 11, the subject matter of examples 8-10 can optionally include wherein the covariate comprises a known fact associated with the plurality of user devices providing the sensor data, the known fact being disentangled from the triplets prior to training.

In example 12, the subject matter of examples 8-11 can optionally include wherein the covariate comprises one or more of an operating system, phone model, or collection mode.

In example 13, the subject matter of examples 8-12 can optionally include wherein the event comprises co-presence of a driver and rider, fraud, dangerous driving, detection of an accident, phone handling issue, or a trip state.

In example 14, the subject matter of examples 8-13 can optionally include preprocessing the sensor data prior to the assembling to align the sensor data to a lower frequency.

Example 15 is a machine-storage medium for training models and using the models to detect events. The machine-storage medium configures one or more processors to perform operations comprising accessing sensor data from a plurality of user devices; assembling one or more triplets using the sensor data, the assembling including applying a weak label; autoencoding the one or more triplets based on a covariate to generate a disentangled embedding; and training an inference model using the disentangled embedding, the inference model being used at runtime to detect whether an event associated with the inference model is present.

In example 16, the subject matter of example 15 can optionally include wherein the operations further comprise, during runtime, autoencoding runtime sensor data from the real world to generate a runtime embedding, the runtime sensor data comprising sensor data from at least one of a device of a driver or a device of a rider; comparing the runtime embedding to one or more embeddings of the inference model, a similarity in the comparing indicating the event associated with the inference model occurring in the real world; and outputting a result of the comparing.

In example 17, the subject matter of examples 15-16 can optionally include wherein the outputting the result comprises providing a notification to at least one of the device of the driver or the device of the rider indicating the event.

In example 18, the subject matter of examples 15-17 can optionally include wherein the covariate comprises a known fact associated with the plurality of user devices providing the sensor data, the known fact being disentangled from the triplets prior to training.

In example 19, the subject matter of examples 15-18 can optionally include wherein the event comprises co-presence of a driver and rider, fraud, dangerous driving, detection of an accident, phone handling issue, or a trip state.

In example 20, the subject matter of examples 15-19 can optionally include wherein the operations further comprise preprocessing the sensor data prior to the assembling to align the sensor data to a lower frequency.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense

What is claimed is:

1. A system comprising:
one or more hardware processors; and
a memory storing instructions that, when executed by the one or more hardware processors, causes the one or more hardware processors to perform operations comprising:
accessing sensor data from a plurality of user devices;
assembling one or more triplets using the sensor data, the assembling including applying a weak label;
autoencoding the one or more triplets based on a covariate to generate a disentangled embedding; and
training an inference model using the disentangled embedding, the inference model being used at runtime to detect whether an event associated with the inference model is present.

2. The system of claim 1, wherein the operations further comprise, during runtime:
autoencoding runtime sensor data from the real world to generate a runtime embedding, the runtime sensor data comprising sensor data from at least one of a device of a driver or a device of a rider;
comparing the runtime embedding to one or more embeddings of the inference model, a similarity in the comparing indicating the event associated with the inference model occurring in the real world; and
outputting a result of the comparing.

3. The system of claim 2, wherein the outputting the result comprises providing a notification to at least one of the device of the driver or the device of the rider indicating the event.

4. The system of claim 1, wherein the covariate comprises a known fact associated with the plurality of user devices providing the sensor data, the known fact being disentangled from the triplets prior to training.

5. The system of claim 4, wherein the covariate comprises one or more of an operating system, phone model, or collection mode.

6. The system of claim 1, wherein the event comprises co-presence of a driver and rider, fraud, dangerous driving, detection of an accident, phone handling issue, or a trip state.

7. The system of claim 1, wherein the operations further comprise preprocessing the sensor data prior to the assembling to align the sensor data to a lower frequency.

8. A method comprising:
accessing, by a networked system, sensor data from a plurality of user devices;
assembling, by a processor of the networked system, one or more triplets using the sensor data, the assembling including applying a weak label;
autoencoding the one or more triplets based on a covariate to generate a disentangled embedding; and
training an inference model using the disentangled embedding, the inference model being used at runtime to detect whether an event associated with the inference model is present.

9. The method of claim 8, further comprising, during runtime:
autoencoding runtime sensor data from the real world to generate a runtime embedding, the runtime sensor data comprising sensor data from at least one of a device of a driver or a device of a rider;
comparing the runtime embedding to one or more embeddings of the inference model, a similarity in the comparing indicating the event associated with the inference model occurring in the real world; and
outputting a result of the comparing.

10. The method of claim 9, wherein the outputting the result comprises providing a notification to at least one of the device of the driver or the device of the rider indicating the event.

11. The method of claim 8, wherein the covariate comprises a known fact associated with the plurality of user devices providing the sensor data, the known fact being disentangled from the triplets prior to training.

12. The method of claim 11, wherein the covariate comprises one or more of an operating system, phone model, or collection mode.

13. The method of claim 8, wherein the event comprises co-presence of a driver and rider, fraud, dangerous driving, detection of an accident, phone handling issue, or a trip state.

14. The method of claim 8, further comprising preprocessing the sensor data prior to the assembling to align the sensor data to a lower frequency.

15. A machine-storage medium storing instructions that when executed by one or more hardware processors of a machine, cause the machine to perform operations comprising:
accessing sensor data from a plurality of user devices;
assembling one or more triplets using the sensor data, the assembling including applying a weak label;
autoencoding the one or more triplets based on a covariate to generate a disentangled embedding; and
training an inference model using the disentangled embedding, the inference model being used at runtime to detect whether an event associated with the inference model is present.

16. The machine-storage medium of claim 15, wherein the operations further comprise, during runtime:
autoencoding runtime sensor data from the real world to generate a runtime embedding, the runtime sensor data comprising sensor data from at least one of a device of a driver or a device of a rider;
comparing the runtime embedding to one or more embeddings of the inference model, a similarity in the comparing indicating the event associated with the inference model occurring in the real world; and
outputting a result of the comparing.

17. The machine-storage medium of claim 16, wherein the outputting the result comprises providing a notification to at least one of the device of the driver or the device of the rider indicating the event.

18. The machine-storage medium of claim 15, wherein the covariate comprises a known fact associated with the plurality of user devices providing the sensor data, the known fact being disentangled from the triplets prior to training.

19. The machine-storage medium of claim 15, wherein the event comprises co-presence of a driver and rider, fraud, dangerous driving, detection of an accident, phone handling issue, or a trip state.

20. The machine-storage medium of claim 15, wherein the operations further comprise preprocessing the sensor data prior to the assembling to align the sensor data to a lower frequency.
